(19) United States
(12) Patent Application Publication
(10) Pub. No.: US 2003/0099503 A1
(43) Pub. Date: May 29, 2003

(54) Binder strap system

(76) Inventor: Marc Lyman Moor, Oakwood, OH (US)

Correspondence Address: Michael S. Neustel, Suite No. 4, 2534 South University Drive, Fargo, ND, 58103, US

(21) Appl. No.: 09/990,113

(22) Filed: Nov. 21, 2001

(51) Int. Cl. B42F 13/00

(52) U.S. Cl. 402/73

(57) ABSTRACT

A binder strap system for facilitating easy handling of a binder. The binder strap system includes a binder, a depression extending into a first portion of the binder, and an elongate strap member attached to the first portion extending across the depression. The strap member has a first segment, a second segment and a third segment, wherein the second segment traverses the depression. A user inserts their fingers within the depression beneath the second segment for carrying the binder. The first segment and the second segment are preferably sewn directly to the first portion to reinforce the strap member. A first fastener and a second fastener are preferably attached to the strap member and the first portion of the binder for increasing the attachment of the strap member to the binder.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to binders and more specifically it relates to a binder strap system for facilitating easy handling of a binder.

2. Description of the Prior Art

Binders have been in use for years. Typically, a conventional binder is comprised of a first portion pivotally attached to a second portion. The first portion is typically attachable to the second portion for “closing” the binder when storage of documents and related items is desirable. A conventional binder is designed for receiving and storing various items such as papers and books.

The main problem with conventional binders is that they are difficult to grasp and carry, particularly when fully loaded with documents. Another problem with conventional binders is that individuals are forced to grasp an upper portion of the binder with their hands which results in their hands slipping from the binder. A further problem with conventional binders is that they sometimes accidentally become dislodged from the user's hands.

While these devices may be suitable for the particular purpose to which they address, they are not as suitable for facilitating easy handling of a binder. Conventional binders are difficult to grasp and carry, particularly when fully loaded with documents.

In these respects, the binder strap system according to the present invention substantially departs from the conventional concepts and designs of the prior art, and in so doing provides an apparatus primarily developed for the purpose of facilitating easy handling of a binder.

### SUMMARY OF THE INVENTION

In view of the foregoing disadvantages inherent in the known types of binders now present in the prior art, the present invention provides a new binder strap system construction wherein the same can be utilized for facilitating easy handling of a binder.

The general purpose of the present invention, which will be described subsequently in greater detail, is to provide a new binder strap system that has many of the advantages of the binders mentioned heretofore and many novel features that result in a new binder strap system which is not anticipated, rendered obvious, suggested, or even implied by any of the prior art binders, either alone or in any combination thereof.

To attain this, the present invention generally comprises a binder, a depression extending into a first portion of the binder, and an elongate strap member attached to the first portion extending across the depression. The strap member has a first segment, a second segment and a third segment, wherein the second segment traverses the depression. A user inserts their fingers within the depression beneath the second segment for carrying the binder. The first segment and the second segment are preferably sewn directly to the first portion to reinforce the strap member. A first fastener and a second fastener are preferably attached to the strap member and the first portion of the binder for increasing the attachment of the strap member to the binder.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a binder strap system that will overcome the shortcomings of the prior art devices.

A second object is to provide a binder strap system for facilitating easy handling of a binder.

Another object is to provide a binder strap system that reduces the likelihood of accidentally dropping a binder.

An additional object is to provide a binder strap system that reduces stresses upon an individual's hands during handling of a binder.

A further object is to provide a binder strap system that does not interfere with the normal operation of the binder.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention grasped by an individual.

FIG. 3 is a cross sectional view taken along line 3-3 of FIG. 1.

FIG. 4 is a top view of the present invention.

FIG. 5 is a cross sectional view taken along line 5-5 of FIG. 1.

### DESCRIPTION OF THE PREFERRED EMBODIMENT

A. Overview

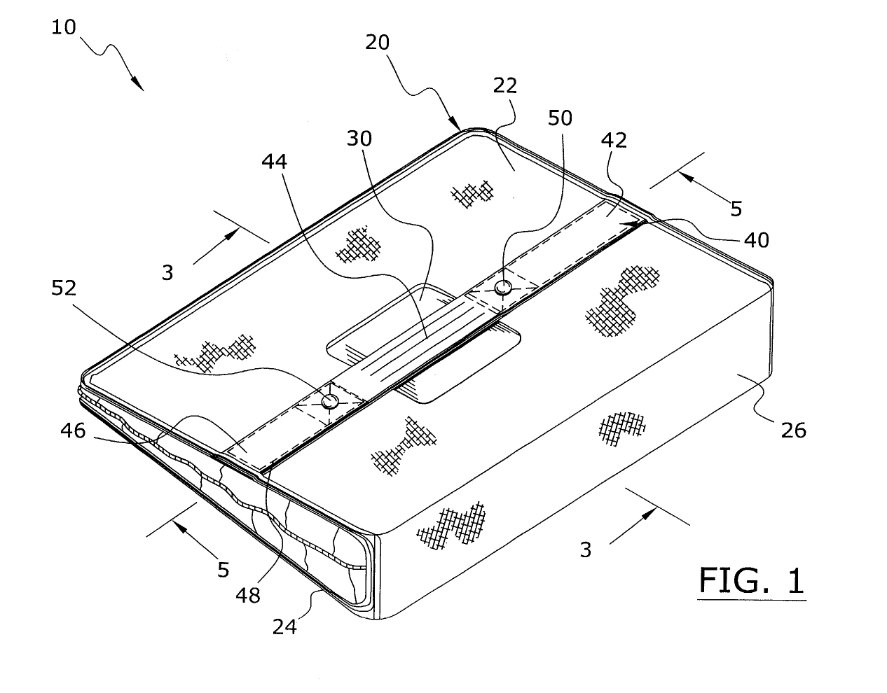

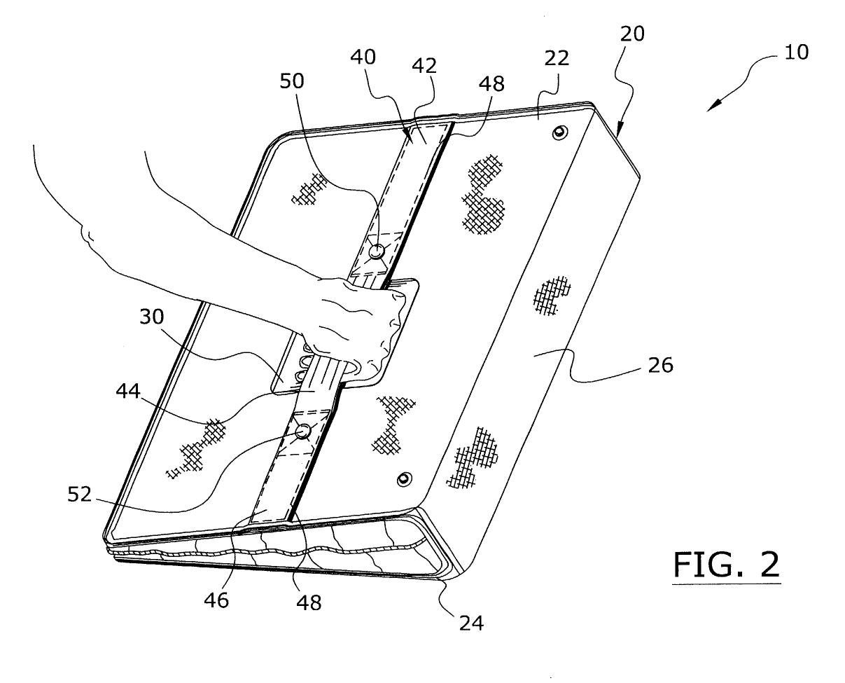

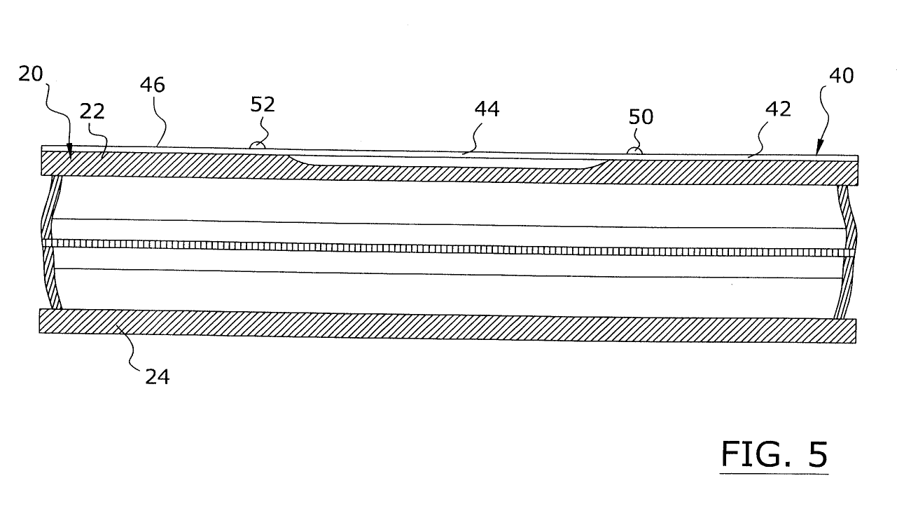

Turning now descriptively to the drawings, in which similar reference characters denote similar elements throughout the several views, FIGS. 1 through 5 illustrate a binder strap system 10, which comprises a binder 20, a depression 30 extending into a first portion 22 of the binder 20, and an elongate strap member 40 attached to the first portion 22 extending across the depression 30. The strap member 40 has a first segment 42, a second segment 44 and a third segment 46, wherein the second segment 44 traverses the depression 30. A user inserts their fingers within the depression 30 beneath the second segment 44 for carrying the binder 20. The first segment 42 and the second segment 44 are preferably sewn directly to the first portion 22 to reinforce the strap member 40. A first fastener 50 and a second fastener 52 are preferably attached to the strap member 40 and the first portion 22 of the binder 20 for increasing the attachment of the strap member 40 to the binder 20.

B. Binder

As shown in FIGS. 1 through 4 of the drawings, the binder 20 is comprised of a first portion 22 and a second portion 24 pivotally attached to a third portion 26 between thereof. The first portion 22 and the second portion 24 may be comprised of various materials and structures.

It can be appreciated that the binder 20 may be comprised of various other configurations, structures and styles which are well known in the art. Various fastening means may be utilized for selectively attaching the first portion 22 to the second portion 24 during usage thereof. The binder 20 shown within FIGS. 1 through 4 is merely for illustration purposes of an exemplary binder 20 that the present invention may be utilized upon. The binder 20 shown within the figures should not limit the various other types and styles of binders 20 the present invention may be utilized upon.

C. Depression

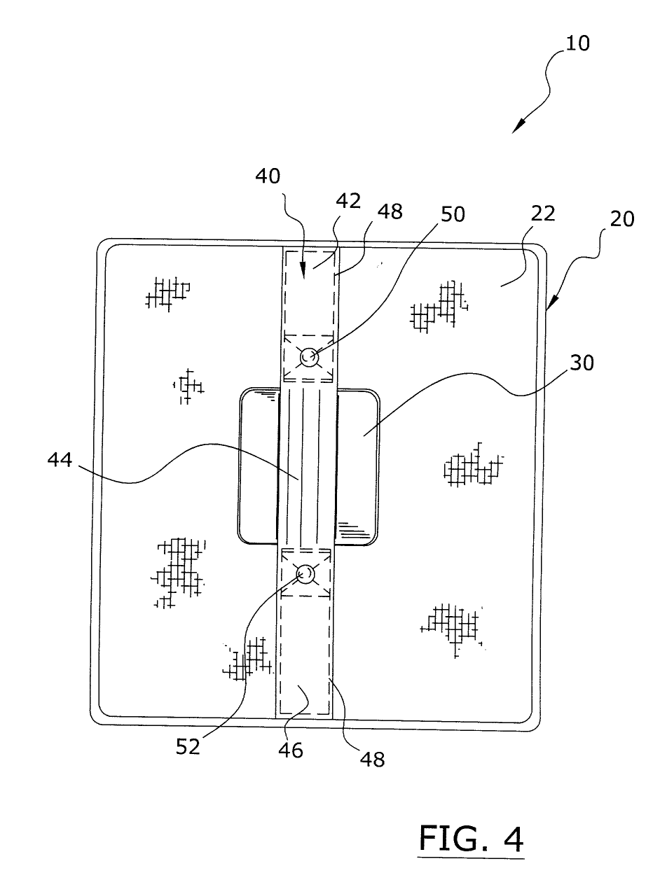

As shown in FIGS. 1 through 4 of the drawings, a depression 30 extends into an exterior portion of the first portion 22. The depression 30 is preferably centered with the strap member 40 as shown in FIG. 4. If the depression 30 has a longitudinal axis, the longitudinal axis is preferably aligned within a longitudinal axis of the strap member 40 as further shown in FIG. 4 of the drawings. In addition, the depression 30 preferably is positioned within a central portion of the first portion 22 of the binder 20 as shown in FIG. 4 of the drawings to facilitate balancing of the binder 20 during carrying thereof.

The depression 30 extends into the first portion 22 at least 0.05 inches for assisting an individual to insert their fingers beneath the second segment 44 of the strap member 40. The depth of the depression 30 may be constant throughout the depression 30 or the depth may vary through the depression 30. The depression 30 may be formed within the first portion 22 utilizing conventional manufacturing methods.

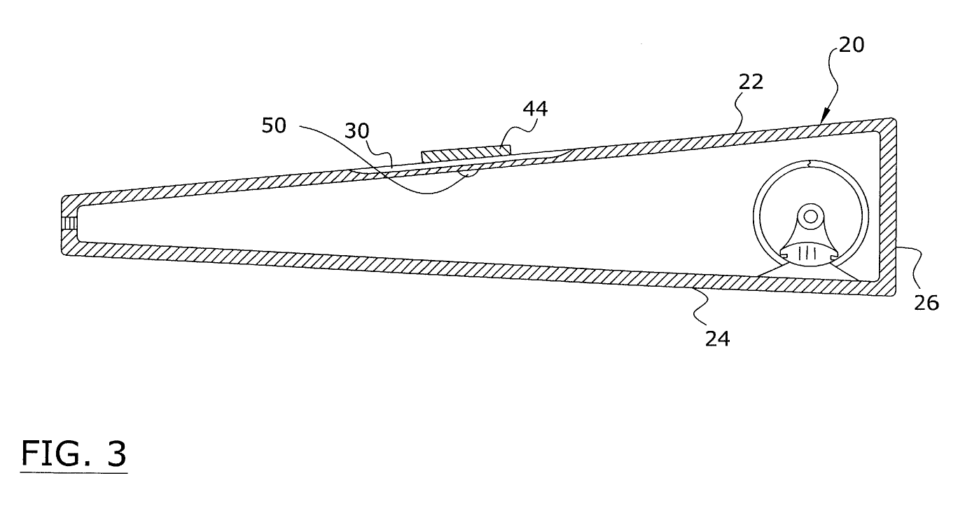

As best shown in FIG. 3 of the drawings, the outer edges of the depression 30 are preferably rounded to facilitate entry of an individual's fingers beneath the strap member 40. The depression 30 is preferably rectangular shaped as shown in FIGS. 1, 2 and 4 of the drawings. As best shown in FIG. 4 of the drawings, each of the four corners of the depression 30 are preferably rounded. The depression 30 may also have various other shapes such as but not limited to circular, square, triangular, oval, and polygonal.

The depression 30 has a width preferably greater than a width of the strap member 40 as best shown in FIG. 4 of the drawings. More particularly, the depression 30 preferably extends at least 0.50 inches on each side of the strap member 40 as shown in FIG. 4 of the drawings.

D. Strap Member

As shown in FIGS. 1, 2 and 4 of the drawings, the strap member 40 preferably has a length sufficient to extend across the entire first portion 22. The strap member 40 may have various widths that are conducive for grasping by an individual such as but not limited to 1.50 inches. The strap member 40 is comprised of a non-elastic, flexible material such as but not limited to nylon and plastic. The strap member 40 may be comprised of a solid or weaved material.

The strap member 40 is preferably secured along the first portion 22 of the binder 20 in a relatively taut manner. The strap member 40 is basically comprised of a first segment 42, a second segment 44 and a third segment 46 as shown in FIGS. 1, 2, 4 and 5 of the drawings.

The first segment 42 is attached to the first portion 22 of the binder 20 on a first side of the depression 30 as best shown in FIGS. 1, 2 and 4 of the drawings. The first segment 42 may be secured utilizing various attachment devices and means. A plurality of threading 48 is illustrated within FIGS. 1, 2 and 4 of the drawings illustrating the first segment 42 being sewn to the first portion 22. The threading 48 preferably extends along the opposing sides of the first segment 42 parallel to the longitudinal axis of the strap member 40 from the edge of the first portion 22 to the edge of the depression 30 as shown in FIG. 4 of the drawings. As shown in FIGS. 1, 2 and 4 of the drawings, a first fastener 50 preferably attaches the first segment 42 adjacent to the depression 30 on the first side thereof. The first fastener 50 may be comprised of various fastener devices that are well known in the art. As best shown in FIG. 4 of the drawings, the threading 48 extends in a square manner with an X pattern about the first fastener 50 for increasing the strength of the attachment of the strap member 40 adjacent to the depression 30 where the greatest stresses will be encountered during usage of the present invention.

As shown in FIGS. 1, 2 and 4 of the drawings, the strap member 40 further includes a second segment 44 extending from the first segment 42 in a continuous manner. The second segment 44 extends across the entire length of the depression 30 in a taut manner as best shown in FIG. 4 of the drawings. The second segment 44 is preferably taut to avoid interfering with the usage and operation of the binder 20. The second segment 44 is further taut to avoid catching upon exterior objects. As shown in FIG. 3 of the drawings, the depression 30 provides a relatively small space between the second segment 44 and the first portion 22 of the binder 20 for allowing an individual to insert their hand between. When an individual inserts their hand beneath the second segment 44, the first portion 22 is typically bowed inwardly to compensate for the thickness of the user's fingers which are typically greater than the depth of the depression 30.

The third segment 46 extends from the second segment 44 and is attached to the first portion 22 of the binder 20 on a second side of the depression 30 opposite of the first segment 42 as best shown in FIGS. 1, 2 and 4 of the drawings. The third segment 46 may be secured utilizing various attachment devices and means similar to the first segment 42. A plurality of threading 48 is illustrated within FIGS. 1, 2 and 4 of the drawings illustrating the third segment 46 being sewn to the first portion 22. The threading 48 preferably extends along the opposing sides of the third segment 46 parallel to the longitudinal axis of the strap member 40 from the edge of the first portion 22 to the edge of the depression 30 as shown in FIG. 4 of the drawings. As shown in FIGS. 1, 2 and 4 of the drawings, a second fastener 52 preferably attaches the third segment 46 adjacent to the depression 30 on the second side thereof. The second fastener 52 may be comprised of various fastener devices that are well known in the art. As best shown in FIG. 4 of the drawings, the threading 48 extends in a square manner with an X pattern about the second fastener 52 for increasing the strength of the attachment of the strap member 40 adjacent to the depression 30 where the greatest stresses will be encountered during usage of the present invention. The first segment 42 and the third segment 46 maintain the strap member 40 preferably in constant stress thereby providing a relatively taut structure for the second segment 44.

E. Usage of Invention

To utilize the present invention, the user first inserts the tips of their fingers within the depression 30 between the second segment 44 and the first portion 22 of the binder 20. Because the strap member 40 is comprised of a generally bendable material, an edge portion of the second segment 44 is able to lifted upwardly to guide the fingers beneath the strap member. The user then forces their fingers beneath the second segment 44 thereby causing the first portion 22 of the binder 20 to become slightly bowed inwardly thereby increasing the space between the second segment 44 and the first portion 22 of the binder 20. The user continues to insert their fingers until tightly retained beneath the strap member 40. The user may then handle and carry the binder 20 in any desired manner. When finished with the present invention, the user simply removes their fingers from the beneath the second segment 44 where after the first portion 22 of the binder 20 returns to an unbowed structure.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Binder Strap System

□ ENVIRONMENTAL ELEMENTS
□
□
□
□
□
□
□
□
□
□ 10. Binder Strap System
□ 11.
□ 12.
□ 13.
□ 14.
□ 15.
□ 16.
□ 17.
□ 18.
□ 19.
□ 20. Binder
□ 21.
□ 22. First Portion
□ 23.
□ 24. Second Portion
□ 25.
□ 26. Third Portion
□ 27.
□ 28.
□ 29.
□ 30. Depression
□ 31.
□ 32.
□ 33.
□ 34.
□ 35.
□ 36.
□ 37.
□ 38.
□ 39.
□ 40. Strap Member
□ 41.
□ 42. First Segment
□ 43.
□ 44. Second Segment
□ 45.
□ 46. Third Segment
□ 47.
□ 48. Threading
□ 49.
□ 50. First Fastener
□ 51.
□ 52. Second Fastener
□ 53.
□ 54.
□ 55.
□ 56.
□ 57.
□ 58.
□ 59.
□ 60.
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.

I claim:

1. A binder strap system for a binder, wherein said binder includes at least a first portion and a second portion attached to one another, comprising:
a depression extending into an exterior surface of said first portion;
a strap member having a first segment, a second segment and a third segment;
wherein said first segment is attached to said first portion on a first side of said depression;
wherein said third segment is attached to said first portion on a second side of said depression opposite of said first segment; and
wherein said second segment extends between said first segment and said third segment in a continuous structure.

2. The binder strap system of claim 1, wherein said second segment is retained within a taut state.

3. The binder strap system of claim 2, wherein said strap member is comprised of a non-elastic material.

4. The binder strap system of claim 1, wherein said strap member extends an entire length of said first portion.

5. The binder strap system of claim 1, wherein a width of said depression is greater than a width of said strap member.

6. The binder strap system of claim 5, wherein said width of said depression is at least one inch greater than said width of said strap member.

7. The binder strap system of claim 1, wherein said depression has a depth of at least 0.05 inches.

8. The binder strap system of claim 1, wherein said depression has a constant depth of at least 0.05 inches.

9. The binder strap system of claim 8, wherein an edge portion of said depression is curved.

10. The binder strap system of claim 1, wherein said depression is positioned within a central position within said first portion and wherein said strap member has a longitudinal axis that is aligned with a longitudinal axis of said depression.

11. A binder strap system for a binder, wherein said binder includes at least a first portion and a second portion attached to one another, comprising:
a depression extending into an exterior surface of said first portion;
wherein said depression has a rectangular shape having a four rounded corners;
a strap member having a first segment, a second segment and a third segment;
wherein said first segment is attached to said first portion on a first side of said depression;
wherein said third segment is attached to said first portion on a second side of said depression opposite of said first segment; and
wherein said second segment extends between said first segment and said third segment in a continuous structure.

12. The binder strap system of claim 11, wherein said second segment is retained within a taut state.

13. The binder strap system of claim 12, wherein said strap member is comprised of a non-elastic material.

14. The binder strap system of claim 11, wherein said strap member extends an entire length of said first portion.

15. The binder strap system of claim 11, wherein a width of said depression is greater than a width of said strap member.

16. The binder strap system of claim 15, wherein said width of said depression is at least one inch greater than said width of said strap member.

17. The binder strap system of claim 11, wherein said depression has a depth of at least 0.05 inches.

18. The binder strap system of claim 11, wherein said depression has a constant depth of at least 0.05 inches.

19. The binder strap system of claim 18, wherein an edge portion of said depression is curved.

20. The binder strap system of claim 11, wherein said depression is positioned within a central position within said first portion and wherein said strap member has a longitudinal axis that is aligned with a longitudinal axis of said depression.
